(19) United States
(12) Patent Application Publication
(10) Pub. No.: US 2024/0166783 A1
(43) Pub. Date: May 23, 2024

(54) RUBBER COMPOSITION

(71) Applicant: COMPAGNIE GENERALE DES ETABLISSEMENTS MICHELIN, CLERMONT-FERRAND (FR)

(72) Inventors: Kahina MAMMERI, CLERMONT-FERRAND Cedex 9 (FR); Emma MORESO, CLERMONT-FERRAND Cedex 9 (FR)

(21) Appl. No.: 18/549,774

(22) PCT Filed: Feb. 21, 2022
(86) PCT No.: PCT/FR2022/050304

§ 371 Date: Sep. 8, 2023

(30) Foreign Application Priority Data
Mar. 11, 2021 (FR) FR2102399

(51) Int. Cl. C08F 210/16; B60C 1/00; C08L 23/08

(52) U.S. Cl. CPC C08F 210/16; B60C 1/0016; C08L 23/083; C08L 2207/04

(57) ABSTRACT

The invention relates to a rubber composition which comprises a reinforcing filler, a vulcanization system and more than 50 to 100 phr of an elastomer which contains more than 50 mol % of ethylene units and which is a copolymer of ethylene, of a first 1,3-diene which is 1,3-butadiene, isoprene or a mixture thereof, and of a second 1,3-diene of formula CH₂═CR—CH═CH₂, the symbol R representing an unsaturated aliphatic hydrocarbon chain having 3 to 20 carbon atoms.

This U.S. patent application is a national phase entry of international patent application no. PCT/FR2022/050304, filed Feb. 21, 2022, which claims priority to French patent application no. FR2102399, filed Mar. 11, 2021, the entire contents of which are incorporated herein by reference in their entirety.

### BACKGROUND

### 1. Technical Field

The present invention relates to diene rubber compositions intended to be used in a tyre which predominantly contain, as elastomer, a copolymer of ethylene and of 1,3-dienes.

### 2. Related Art

The diene rubber compositions customarily used in tyres are rubber compositions reinforced with highly unsaturated diene elastomers such as polybutadienes, polyisoprenes, and copolymers of butadiene and styrene.

It has been proposed, in particular in document WO 2014114607, to use copolymers of ethylene and of 1,3-butadiene in rubber compositions for tyres. These copolymers which contain more than 50 mol % of ethylene units are described as highly saturated diene elastomers.

The rubber compositions comprising these highly saturated diene elastomers require relatively long residence times in a curing press to be vulcanized, which results in a reduction in the productivity of a production line for articles containing these rubber compositions, such as tyres. Moreover, these rubber compositions, once vulcanized, exhibit a much higher stiffness than the diene rubber compositions customarily used and may therefore prove unsuitable for certain applications. The level of stiffness of a rubber composition is defined partly by the degree of vulcanization of the rubber, which depends both on the vulcanization kinetics and on the residence time of the rubber composition in the curing press. The solution that would consist quite simply in extracting the rubber composition from the curing press before the end of the vulcanization reaction is not satisfactory, because it would lead to an insufficiently cured rubber composition that would then be more hysteretic.

The applicant has discovered a reinforced rubber composition based on a copolymer of ethylene and of 1,3-dienes which makes it possible to solve the difficulties encountered and which therefore has the advantage of having an improved compromise between the properties of stiffness, hysteresis and curing.

Thus, a first subject of the invention is a rubber composition which comprises a reinforcing filler, a vulcanization system and more than 50 to 100 phr of an elastomer which contains more than 50 mol % of ethylene units and which is a copolymer of ethylene, of a first 1,3-diene which is 1,3-butadiene, isoprene or a mixture thereof, and of a second 1,3-diene of formula CH₂═CR—CH═CH₂, the symbol R representing an unsaturated aliphatic hydrocarbon chain having 3 to 20 carbon atoms.

Another subject of the invention is a tyre which comprises a tread, which tyre comprises a rubber composition in accordance with the invention, in particular in the tread of said tyre.

### DESCRIPTION

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

The abbreviation “phr” means parts by weight per hundred parts of elastomer (of the total of the elastomers if several elastomers are present).

The compounds mentioned in the description may be of fossil origin or may be biobased. In the latter case, they may be partially or completely derived from biomass or may be obtained from renewable starting materials derived from biomass. Similarly, the compounds mentioned may also originate from the recycling of already-used materials, i.e. they may be partially or totally derived from a recycling process, or obtained from starting materials which are themselves derived from a recycling process.

In the present invention, the term “tyre” is understood to mean a pneumatic or non-pneumatic tyre. A pneumatic tyre usually includes two beads intended to come into contact with a rim, a crown composed of at least one crown reinforcement and a tread, two sidewalls, the tyre being reinforced by a carcass reinforcement anchored in the two beads. A non-pneumatic tyre, for its part, usually comprises a base, designed for example for mounting on a rigid rim, a crown reinforcement, ensuring the connection with a tread and a deformable structure, such as spokes, ribs or cells, this structure being placed between the base and the crown. Such non-pneumatic tyres do not necessarily include a sidewall. Non-pneumatic tyres are described for example in documents WO 03/018332 and FR2898077. According to any one of the embodiments of the invention, the tyre according to the invention is preferentially a pneumatic tyre.

Unless otherwise indicated, the contents of the units resulting from the insertion of a monomer into a copolymer such as the copolymer of use in the invention are expressed as molar percentage relative to all of the monomer units of the polymer.

The elastomer of use for the requirements of the invention is a copolymer of ethylene, of a first 1,3-diene and of a second 1,3-diene.

The first 1,3-diene is 1,3-butadiene, isoprene or a mixture thereof, that is to say a mixture of 1,3-butadiene and isoprene. The first 1,3-diene is preferentially 1,3-butadiene.

The second 1,3-diene corresponds to formula (I) in which the symbol R represents an unsaturated aliphatic hydrocarbon chain having from 3 to 20 carbon atoms.

CH₂═CR—CH═CH₂ (I)

The second 1,3-diene is just one compound, that is to say just one 1,3-diene of formula (I), or is a mixture of 1,3-dienes of formula (I), the 1,3-dienes of the mixture differing from one another in the group represented by the symbol R.

Preferably, the chain represented by R contains 6 to 16 carbon atoms. It can be a linear or branched chain, in which case the symbol R represents a linear or branched chain. Preferably, the hydrocarbon chain is acyclic, in which case the symbol R represents an acyclic chain. Better still, the symbol R represents an unsaturated and branched acyclic hydrocarbon chain. The hydrocarbon chain represented by the symbol R is advantageously an unsaturated and branched acyclic chain containing from 3 to 20 carbon atoms, in particular from 6 to 16 carbon atoms. Very advantageously, the 1,3-diene is myrcene, β-farnesene or a mixture of myrcene and β-farnesene.

According to a preferential embodiment of the invention, the 1,3-diene is myrcene.

According to another preferential embodiment of the invention, the 1,3-diene is β-farnesene.

Since the copolymer is a copolymer of ethylene, of a first 1,3-diene and of a second 1,3-diene, the monomer units of the copolymer are units resulting from the polymerization of ethylene, of the first 1,3-diene and of the second 1,3-diene. The copolymer thus comprises ethylene units, units of the first 1,3-diene and units of the second 1,3-diene.

Since the second 1,3-diene is a substituted 1,3-diene, its polymerization can give rise to units of 1,2 configuration represented by the formula (1), of 3,4 configuration represented by the formula (2) and of 1,4 configuration, the trans form of which is represented below by the formula (3).

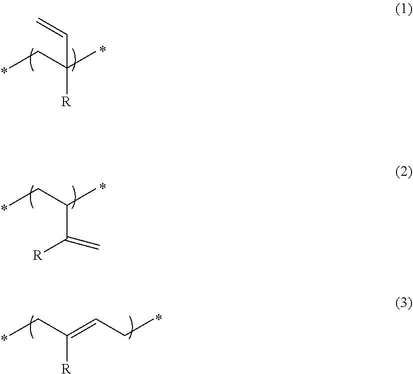

In a well known way, the first 1,3-diene can give rise to 1,3-diene units which are units of 1,2 or 3,4 configuration, as is the case, for example, of isoprene, and units of 1,4 configuration.

In an also well known way, the ethylene unit is a unit of —(CH₂—CH₂)— moiety.

The copolymer of use in the invention is advantageously a statistical copolymer according to any one of the embodiments of the invention. Very advantageously, the copolymer is an atactic polymer according to any one of the embodiments of the invention.

According to the invention, the copolymer contains more than 50 mol % of ethylene units. Preferably, the copolymer contains more than 60 mol % of ethylene units. More referentially, it contains at least 70 mol % of ethylene units. The copolymer preferentially contains at most 85 mol % of ethylene units.

Preferably, the copolymer contains less than 30 mol % of units of the second 1,3-diene. More preferentially, the copolymer contains at most 20 mol % of units of the second 1,3-diene. Even more preferentially, the copolymer contains at most 15 mol % of units of the second 1,3-diene.

According to one embodiment, the copolymer contains less than 30 mol % of units of the first 1,3-diene.

According to another embodiment, the copolymer contains less than 20 mol % of units of the first 1,3-diene.

Preferably, the copolymer contains less than 20 mol % of units of the first 1,3-diene.

According to one embodiment of the invention, the copolymer contains more than 60 mol % to 90 mol % of ethylene units and less than 30 mol %, preferentially at most 20 mol % of units of the second 1,3-diene, more preferentially at most 15 mol % of units of the second 1,3-diene. According to this embodiment of the invention, the copolymer preferentially contains less than 30 mol % of units of the first 1,3-diene or preferentially contains less than 20 mol % of units of the first 1,3-diene.

According to another embodiment of the invention, the copolymer contains from 70 mol % to 90 mol % of ethylene units and less than 30 mol %, preferentially at most 20 mol % of units of the second 1,3-diene, more preferentially at most 15 mol % of units of the second 1,3-diene. According to this embodiment of the invention, the copolymer preferentially contains less than 20 mol % of units of the first 1,3-diene.

According to yet another embodiment of the invention, the copolymer contains more than 60 mol % to 85 mol % of ethylene units and less than 30 mol %, preferentially at most 20 mol %, more preferentially at most 15 mol % of units of the second 1,3-diene. According to this embodiment of the invention, the copolymer preferentially contains less than 30 mol % of units of the first 1,3-diene or preferentially contains less than 20 mol % of units of the first 1,3-diene.

According to yet another embodiment of the invention, the copolymer contains from 70 mol % to 85 mol % of ethylene units and less than 30 mol %, preferentially at most 20 mol %, more preferentially at most 15 mol % of units of the second 1,3-diene. According to this embodiment of the invention, the copolymer preferentially contains less than 20 mol % of units of the first 1,3-diene.

According to any one of the embodiments of the invention, the copolymer preferentially contains less than 80 mol % of ethylene units.

According to any one of the embodiments of the invention, the copolymer preferentially contains at least 1 mol % of units of the second 1,3-diene, more preferentially at least 5 mol % of units of the second 1,3-diene.

According to one particular embodiment of the invention, in particular when the first 1,3-diene is 1,3-butadiene or a mixture of 1,3-butadiene and isoprene, the copolymer also contains 1,2-cyclohexanediyl moieties. The presence of these cyclic structures in the copolymer results from a very specific insertion of the ethylene and 1,3-butadiene during the polymerization. The content of 1,2-cyclohexanediyl moieties in the copolymer varies according to the respective contents of ethylene and of 1,3-butadiene in the copolymer. The copolymer preferably contains less than 15 mol % of units of 1,2-cyclohexanediyl moiety.

Preferably, the copolymer has a glass transition temperature of less than −35° C., preferentially of between −70° C. and −35° C.

The copolymer can be prepared by a process which comprises the polymerization of a mixture of ethylene, of the first 1,3-diene and of the second 1,3-diene in the presence of a catalytic system based at least on a metallocene of formula (II) and on an organomagnesium compound of formula (III)

P(Cp¹Cp²)Nd(BH₄)_{(1+γ)}-L_{y}-Nₓ (II)

MgR¹R² (III)
Cp¹ and Cp², identical or different, being chosen from the group consisting of the cyclopentadienyl group of formula C₅H₄, the unsubstituted fluorenyl group of formula C₁₃H₈ and substituted fluorenyl groups,
P being a group bridging the two Cp¹ and Cp² groups and representing a ZR³R⁴ group, Z representing a silicon or carbon atom, R³ and R⁴, identical or different, each representing an alkyl group comprising from 1 to 20 carbon atoms, preferably a methyl,
y, which is an integer, being equal to or greater than 0,
x, an integer or not, being equal to or greater than 0,
L representing an alkali metal chosen from the group consisting of lithium, sodium and potassium,
N representing a molecule of an ether, preferably diethyl ether or tetrahydrofuran,
R¹ and R², identical or different, representing a carbon group.

Mention may be made, as substituted fluorenyl groups, of those substituted by alkyl radicals having from 1 to 6 carbon atoms or by aryl radicals having from 6 to 12 carbon atoms. The choice of the radicals is also guided by the accessibility to the corresponding molecules, which are the substituted fluorenes, because the latter are commercially available or can be easily synthesized.

Mention may more particularly be made, as substituted fluorenyl groups, of the 2,7-di(tert-butyl)fluorenyl and 3,6-di(tert-butyl)fluorenyl groups. The 2, 3, 6 and 7 positions respectively denote the position of the carbon atoms of the rings as represented in the diagram below, the 9 position corresponding to the carbon atom to which the bridge P is attached.

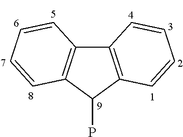

The catalytic system can be prepared conventionally by a process analogous to that described in patent application WO 2007054224 or WO 2007054223. For example, the organomagnesium compound and the metallocene are reacted in a hydrocarbon-based solvent typically at a temperature ranging from 20° C. to 80° C. for a period of time of between 5 and 60 minutes. The catalytic system is generally prepared in an aliphatic hydrocarbon-based solvent such as methylcyclohexane, or an aromatic hydrocarbon-based solvent such as toluene. Generally, after its synthesis, the catalytic system is used in this form in the process for the synthesis of the copolymer.

Alternatively, the catalytic system may be prepared via a process analogous to that described in patent application WO 2017/093654 A1 or in patent application WO 2018/020122 A1. According to this alternative, the catalytic system further contains a preformation monomer chosen from a conjugated diene, ethylene or a mixture of ethylene and a conjugated diene, in which case the catalytic system is based at least on the metallocene, the organomagnesium compound and the preformation monomer. For example, the organomagnesium compound and the metallocene are reacted in a hydrocarbon-based solvent typically at a temperature of from 20° C. to 80° C. for 10 to 20 minutes to obtain a first reaction product, and the preformation monomer, chosen from a conjugated diene, ethylene or a mixture of ethylene and a conjugated diene, is then reacted with this first reaction product at a temperature ranging from 40° C. to 90° C. for 1 hour to 12 hours. The catalytic system thus obtained can be used immediately in the process in accordance with the invention or be stored under an inert atmosphere before it is used in the polymerization process for preparing the copolymer.

The metallocene used for preparing the catalytic system can be in the form of a crystalline or non-crystalline powder, or else in the form of single crystals. The metallocene may be in a monomer or dimer form, these forms depending on the method of preparation of the metallocene, as is described, for example, in patent application WO 2007/054224 or WO 2007/054223. The metallocene can be prepared conventionally by a process analogous to that described in patent application WO 2007054224 or WO 2007054223, in particular by reaction, under inert and anhydrous conditions, of the salt of an alkali metal of the ligand with a rare earth metal borohydride in a suitable solvent, such as an ether, for example diethyl ether or tetrahydrofuran, or any other solvent known to those skilled in the art. After reaction, the metallocene is separated from the reaction by-products via techniques known to those skilled in the art, such as filtration or precipitation from a second solvent. The metallocene is finally dried and isolated in solid form.

Like any synthesis performed in the presence of an organometallic compound, the synthesis of the metallocene and that of the catalytic system take place under anhydrous conditions under an inert atmosphere. Typically, the reactions are performed starting with anhydrous solvents and compounds under anhydrous nitrogen or argon.

The organomagnesium compound used in the catalytic system is of formula MgR¹R², in which R¹ and R², identical or different, represent a carbon group. Carbon group is understood to mean a group which contains one or more carbon atoms. Preferably, R¹ and R² contain from 2 to 10 carbon atoms. More preferentially, R¹ and R² each represent an alkyl. The organomagnesium compound is advantageously a dialkylmagnesium compound, better still butylethylmagnesium or butyloctylmagnesium, even better still butyloctylmagnesium.

The molar ratio of the organomagnesium compound to the metal Nd constituting the metallocene is preferably within a range extending from 1 to 100, more preferentially is greater than or equal to 1 and less than 10. The range of values extending from 1 to less than 10 is in particular more favourable for obtaining copolymers of high molar masses.

When the copolymer is a polymer which comprises 1,2-cyclohexanediyl moieties, it is prepared according to the process mentioned in the present patent application using a metallocene of formula (II) in which Cp¹ and Cp², identical or different, are chosen from the group consisting of substituted fluorenyl groups and the unsubstituted fluorenyl group of formula C₁₃H₈. For this variant, the metallocenes of the following formulae, in which the symbol Flu presents the fluorenyl group of formula C₁₃H₈, are particularly suitable: [{Me₂SiFlu₂Nd(μ-BH₄)₂Li(THF)}₂]; [Me₂SiFlu₂Nd(μ-BH₄)₂Li(THF)]; [Me₂SiFlu₂Nd(μ-BH₄)(THF)]; [{Me₂SiFlu₂Nd(μ-BH₄)(THF)}₂] and [Me₂SiFlu₂Nd(μ-BH₄)], are particularly suitable.

Those skilled in the art also adapt the polymerization conditions and the concentrations of each of the reagents (constituents of the catalytic system, monomers) according to the equipment (tools, reactors) used to perform the polymerization and the various chemical reactions. As is known to those skilled in the art, the polymerization and also the handling of the monomers, of the catalytic system and of the polymerization solvent(s) take place under anhydrous conditions and under an inert atmosphere. The polymerization solvents are typically aliphatic or aromatic hydrocarbon-based solvents.

The polymerization is preferably performed in solution, continuously or batchwise. The polymerization solvent may be an aromatic or aliphatic hydrocarbon-based solvent. Examples of polymerization solvents that may be mentioned include toluene and methylcyclohexane. The monomers may be introduced into the reactor containing the polymerization solvent and the catalytic system or, conversely, the catalytic system may be introduced into the reactor containing the polymerization solvent and the monomers. The copolymerization is typically carried out under anhydrous conditions and in the absence of oxygen, in the optional presence of an inert gas. The polymerization temperature generally varies within a range extending from 30° C. to 150° C., preferentially from 30° C. to 120° C. Preferably, the copolymerization is carried out at constant ethylene pressure.

During the polymerization of ethylene and of 1,3-dienes in a polymerization reactor, ethylene and 1,3-dienes may be added continuously to the polymerization reactor, in which case the polymerization reactor is a fed reactor. This embodiment is most particularly suitable for the synthesis of a statistical copolymer.

The polymerization can be stopped by cooling the polymerization medium or by adding an alcohol. The polymer can be recovered according to conventional techniques known to those skilled in the art, for instance by precipitation, by evaporation of the solvent under reduced pressure or by steam stripping.

Alternatively, instead of adding an alcohol, it is possible to add a functionalizing agent, in which case a polymer bearing a functional group, such as an amine functional group, a silanol functional group or an alkoxysilane functional group, is recovered. According to one particular embodiment of the invention, the copolymer bears an amine, alkoxysilane or silanol function.

According to a first variant in which the functional group borne by the polymer is an amine functional group, the functionalizing agent is preferably a compound of formula (IV),

Si(Fc¹)_{3-g}(Rc²)_{g}(Rca) (IV)

the symbols Fc¹, identical or different, representing an alkoxy group,

the symbols Rc², identical or different, representing a hydrogen atom or a hydrocarbon chain,

the symbol Rca representing a hydrocarbon chain substituted with an amine function,

g being an integer ranging from 0 to 1.

The alkoxy group represented by the symbol Fc¹ in the formula (IV) is preferably methoxy or ethoxy.

The amine functional group designated in the symbol Rca in the formula (IV), namely the amine functional group of the functionalizing agent, is a protected primary amine functional group, a protected secondary amine functional group or a tertiary amine functional group. Protecting groups for the primary amine and secondary amine functions that may be mentioned include silyl groups, for example trimethylsilyl and tert-butyldimethylsilyl groups. Preferably, the amine functional group of the functionalizing agent is a tertiary amine functional group. Advantageously, the amine functional group of the functionalizing agent is a tertiary amine function of formula —N(R_{B})₂ in which each R_{B} represents an alkyl, preferentially a methyl or an ethyl.

Mention may be made, as functionalizing agent for preparing a polymer bearing an amine functional group according to the first variant, of the compounds (N,N-dimethyl-3-aminopropyl)methyldimethoxysilane, (N,N-dimethyl-3-aminopropyl)methyldiethoxysilane, (N,N-dimethyl-3-aminopropyl)ethyldimethoxysilane, (N,N-dimethyl-3-aminopropyl)ethyldiethoxysilane, (N,N-dimethylaminopropyl)trimethoxysilane, (N,N-dimethylaminopropyl)triethoxysilane, (N-(3-trimethoxysilyl)propyl)-N-(trimethylsilyl)silanamine and (N-(3-triethoxysilyl)propyl)-N-(trimethylsilyl)silanamine, preferably (N,N-dimethyl-3-aminopropyl)methyldimethoxysilane, (N,N-dimethyl-3-aminopropyl)ethyldimethoxysilane, (N,N-dimethylaminopropyl)trimethoxysilane and (N-(3-trimethoxysilyl)propyl)-N-(trimethylsilyl)silanamine, more preferably (N,N-dimethylaminopropyl)trimethoxysilane and (N-(3-trimethoxysilyl)propyl)-N-(trimethylsilyl)silanamine.

According to a second variant in which the functional group borne by the polymer is a silanol or alkoxysilane functional group, the functionalizing agent is preferably a compound of formula (V),

Si(Fc¹)_{4-g}(Rc²)_{g} (V)
the symbols Fc¹, identical or different, representing an alkoxy group or a halogen atom,
the symbols Rc², identical or different, representing a hydrogen atom, a hydrocarbon chain or a hydrocarbon chain substituted with a chemical function Fc²,
g being an integer ranging from 0 to 2.

When the symbol Fc¹ represents an alkoxy group in the formula (V), the alkoxy group is preferably methoxy or ethoxy. When the symbol Fc¹ represents a halogen atom in the formula (V), the halogen atom is preferably chlorine.

Among the hydrocarbon chains represented by the symbols Rc² in formula (V), mention may be made of alkyls, preferably alkyls containing not more than 6 carbon atoms, more preferentially methyl or ethyl, better still methyl.

Among the hydrocarbon chains substituted with a chemical function Fc² which are represented by the symbols Rc² in formula (V), mention may be made of alkanediyl chains, preferably those including not more than 6 carbon atoms, more preferentially the 1,3-propanediyl group, the alkanediyl group bearing a substituent, the chemical function Fc², in other words one valency of the alkanediyl chain for the function Fc², the other valency for the silicon atom of the methoxysilane function.

In the formula (V), the term “chemical functional group” is understood to mean a group which is different from a saturated hydrocarbon group and which can participate in chemical reactions. Those skilled in the art understand that the chemical functional group Fc² in the formula (V) is a group chemically inert with respect to the chemical entities present in the polymerization medium. The chemical functional group Fc² in the formula (V) can be in a protected form, such as, for example, in the case of the primary amine, secondary amine or thiol functional group. Chemical functions Fc² that may be mentioned include ether, thioether, protected primary amine, protected secondary amine, tertiary amine, protected thiol and silyl functions. Preferably, the chemical functional group Fc² in the formula (V) is a protected primary amine functional group, a protected secondary amine functional group, a tertiary amine functional group or a protected thiol functional group. As protecting groups for the primary amine, secondary amine and thiol functions, mention may be made of silyl groups, for example the trimethylsilyl and tert-butyldimethylsilyl groups.

Mention may be made, as functionalizing agent for preparing a polymer bearing a silanol or alkoxysilane functional group according to the second variant, of the compounds dimethoxydimethylsilane, diethoxydimethylsilane, dimethoxydiethylsilane, diethoxydiethylsilane, (N,N-dimethyl-3-aminopropyl)methyldimethoxysilane, (N,N-dimethyl-3-aminopropyl)methyldiethoxysilane, (N,N-dimethyl-3-aminopropyl)ethyldimethoxysilane, (N,N-dimethyl-3-aminopropyl)ethyldiethoxysilane, 3-methoxy-3,8,8,9,9-pentamethyl-2-oxa-7-thia-3,8-disiladecane, trimethoxymethylsilane, triethoxymethylsilane, trimethoxyethylsilane, triethoxyethylsilane, (N,N-dimethylaminopropyl)trimethoxysilane, (N,N-dimethylaminopropyl)triethoxysilane, (N-(3-trimethoxysilyl)propyl)-N-(trimethylsilyl)silanamine, (N-(3-triethoxysilyl)propyl)-N-(trimethylsilyl)silanamine and 3,3-dimethoxy-8,8,9,9-tetramethyl-2-oxa-7-thia-3,8-disiladecane, preferably dimethoxydimethylsilane, dimethoxydiethylsilane, (N,N-dimethyl-3-aminopropyl)methyldimethoxysilane, (N,N-dimethyl-3-aminopropyl)ethyldimethoxysilane, 3-methoxy-3,8,8,9,9-pentamethyl-2-oxa-7-thia-3,8-disiladecane, trimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane, more preferably trimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane.

Whether it is the first or the second variant, the functionalizing agent is typically added to the polymerization medium. It is typically added to the polymerization medium at a degree of conversion of the monomers chosen by those skilled in the art according to the desired macrostructure of the copolymer. As the polymerization step is generally carried out under ethylene pressure, a degassing of the polymerization reactor can be carried out before the addition of the functionalizing agent. The functionalizing agent is added under inert and anhydrous conditions to the polymerization medium, maintained at the polymerization temperature. Use is typically made of from 0.25 to 10 mol of functionalizing agent per 1 mol of cocatalyst, preferably of from 2 to 4 mol of functionalizing agent per 1 mol of cocatalyst. The functionalizing agent is brought into contact with the polymerization medium for a time sufficient to make possible the functionalization reaction. This contact time is judiciously chosen by those skilled in the art as a function of the concentration of the reaction medium and of the temperature of the reaction medium. Typically, the functionalization reaction is performed with stirring, at a temperature ranging from 17° C. to 80° C., for 0.01 to 24 hours.

When the functionalizing agent bears a protected functional group as described above, the step of functionalization of the polymer can be followed by a hydrolysis reaction in order to form a copolymer bearing a deprotected functional group, such as a primary amine, a secondary amine or a thiol functional group.

A hydrolysis reaction can also follow the reaction for functionalization of the polymer when the functionalization reaction leads to the formation of a polymer bearing an alkoxysilane function. The hydrolysis of the polymer bearing an alkoxysilane function leads to the preparation of a polymer bearing a silanol function.

The rubber composition according to the invention comprises more than 50 to 100 phr of a copolymer of ethylene, of a first 1,3-diene and of a second 1,3-diene, copolymer as defined in any of the embodiments described above, including their variants. It is understood that the copolymer of ethylene, of a first 1,3-diene and of a second 1,3-diene can be constituted by a mixture of copolymers of ethylene, of a first 1,3-diene and a second 1,3-diene which differ from each other by their microstructure or by their macrostructure. When the content of the copolymer is greater than 50 phr and less than 100 phr, the balance to 100 phr can be provided by another elastomer, in particular another diene elastomer known to those skilled in the art. This other diene elastomer can be an elastomer conventionally used in rubber compositions for tyres such as polybutadienes, polyisoprenes, 1,3-butadiene copolymers and isoprene copolymers. According to one preferred embodiment, the rubber composition comprises 100 phr of a copolymer of ethylene, of a first 1,3-diene and of a second 1,3-diene, copolymer as defined in any one of the embodiments previously described, including variations thereof.

Another essential feature of the rubber composition in accordance with the invention is that it comprises a reinforcing filler. The rubber composition can comprise any type of “reinforcing” filler known for its abilities to reinforce a rubber composition which can be used for the manufacture of tyres, for example an organic filler, such as carbon black, a reinforcing inorganic filler, such as silica, with which is combined, in a known way, a coupling agent, or also a mixture of these two types of filler. Such a reinforcing filler typically consists of nanoparticles, the (mass-)average size of which is less than a micrometre, generally less than 500 nm, usually between 20 and 200 nm, in particular and more preferentially between 20 and 150 nm.

The content of reinforcing filler is adjusted by those skilled in the art according to the use of the rubber composition. According to one embodiment of the invention, the content of reinforcing filler in the rubber composition is greater than or equal to 30 phr and less than or equal to 200 phr, preferably greater than or equal to 35 phr and less than or equal to 100 phr.

The reinforcing filler may be a silica, a carbon black or a mixture of a carbon black and a silica. Preferably, the reinforcing filler comprises a silica which represents more than 50% by weight of the reinforcing filler. More preferentially, the silica represents more than 85% by weight of the reinforcing filler.

The silica used can be any reinforcing silica known to those skilled in the art, in particular any precipitated or fumed silica having a BET specific surface area and also a CTAB specific surface area both of less than 450 m²/g, preferably within a range extending from 30 to 400 m²/g, in particular from 60 to 300 m²/g. In the present disclosure, the BET specific surface is determined by gas adsorption using the Brunauer-Emmett-Teller method described in “The Journal of the American Chemical Society”, (Vol. 60, page 309, February 1938), and more specifically according to a method adapted from Standard NF ISO 5794-1, Appendix E, of June 2010 [multipoint (5 point) volumetric method—gas: nitrogen—degassing under vacuum: one hour at 160° C.—relative pressure p/p₀ range: 0.05 to 0.17].

The CTAB specific surface area values were determined according to Standard NF ISO 5794-1, Appendix G of June 2010. The process is based on the adsorption of CTAB (N-hexadecyl-N,N,N-trimethylammonium bromide) on the “external” surface of the reinforcing filler.

Any type of precipitated silica, in particular highly dispersible precipitated silicas (referred to as “HDS” for “highly dispersible” or “highly dispersible silica”), can be used. These precipitated silicas, which are or are not highly dispersible, are well known to those skilled in the art. Mention may be made, for example, of the silicas described in patent applications WO03/016215-A1 and WO03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silicas, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The silica may be a mixture of various silicas, in which case the proportions of silica in the reinforcing filler relate to all the silicas.

Suitable as carbon blacks are all carbon blacks, in particular the blacks conventionally used in tyres or their treads. Among said carbon blacks, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks may be used in isolated form, as commercially available, or in any other form, for example as support for some of the rubber additives used.

The carbon black may be a mixture of various carbon blacks, in which case the contents of carbon black relate to all the carbon blacks.

According to any one of the embodiments of the invention, the carbon black is preferably used at a content of less than or equal to 20 phr, more preferentially less than or equal to 10 phr (for example the carbon black content may be in a range extending from 0.5 to 20 phr, in particular extending from 1 to 10 phr). Advantageously, the carbon black content in the rubber composition is less than or equal to 5 phr. Within the intervals indicated, the colouring properties (black pigmenting agent) and UV-stabilizing properties of the carbon blacks are beneficial, without, moreover, adversely affecting the typical performance qualities contributed by the silica.

To couple the reinforcing inorganic filler, in this case silica, to the elastomer, it is possible to use, in a well-known manner, an at least bifunctional coupling agent (or bonding agent) intended to ensure a sufficient connection, of chemical and/or physical nature, between the inorganic filler (surface of its particles) and the elastomer, in which case the rubber composition comprises a coupling agent for binding the silica to the elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the elastomer.

Use is in particular made of silane polysulfides, referred to as “symmetrical” or “asymmetrical” depending on their specific structure, as described, for example, in applications WO03/002648-A1 (or US2005/016651-A1) and WO03/002649-A1 (or US2005/016650-A1). Suitable in particular, without the definition below being limiting, are silane polysulfides corresponding to general formula (IV) below in which:

Z-A-Sₓ-A-Z (IV)
x is an integer from 2 to 8 (preferably from 2 to 5);
the A symbols, identical or different, represent a divalent hydrocarbon radical (preferably a C₁-C₁₈ alkylene group or a C₆-C₁₂ arylene group, more particularly a C₁-C₁₀ alkylene, in particular a C₁-C₄ alkylene, in particular propylene);
the Z symbols, identical or different, correspond to one of the three formulae below:

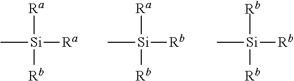

in which:
the R^{a} radicals, which are substituted or unsubstituted and identical to or different from one another, represent a C₁-C₁₈ alkyl group, a C₅-C₁₈ cycloalkyl group or a C₆-C₁₈ aryl group (preferably C₁-C₆ alkyl groups, cyclohexyl or phenyl, in particular C₁-C₄ alkyl groups, more particularly methyl and/or ethyl),
the R^{b} radicals, substituted or unsubstituted and identical to or different from one another, represent a C₁-C₁₈ alkoxyl group or a C₅-C₁₈ cycloalkoxyl group (preferably a group chosen from C₁-C₈ alkoxyls and C₅-C₈ cycloalkoxyls, more preferentially still a group chosen from C₁-C₄ alkoxyls, in particular methoxyl and ethoxyl), or a hydroxyl group, or such that two R^{b} radicals represent a C₃-C₁₈ dialkoxyl group.

In the case of a mixture of alkoxysilane polysulfides corresponding to the above formula (V), in particular normal commercially available mixtures, the mean value of the ‘x’ indices is a fractional number preferably within a range extending from 2 to 5, more preferentially of approximately 4.

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂ sold under the name Si69 by Evonik or bis(triethoxysilylpropyl) disulfide, abbreviated to TESPD, of formula [(C₂H₅O)₃Si(CH₂)₃S]₂ sold under the name Si75 by Evonik. Mention will also be made, as preferred examples, of bis(mono(C₁-C₄)alkoxyldi(C₁-C₄)alkylsilylpropyl) polysulfides (in particular disulfides, trisulfides or tetrasulfides), more particularly of bis(monoethoxydimethylsilylpropyl) tetrasulfide, such as described in the abovementioned patent application WO02/083782-A1 (or U.S. Pat. No. 7,217,751-B2).

Of course, use might also be made of mixtures of the coupling agents described above.

The content of coupling agent in the composition of the invention is advantageously less than or equal to 25 phr, it being understood that it is generally desirable to use as little as possible thereof. Typically, the content of coupling agent represents from 0.5% to 15% by weight, with respect to the amount of reinforcing inorganic filler. Its content is preferably within a range extending from 0.5 to 20 phr, more preferentially within a range extending from 3 to 15 phr. This content is easily adjusted by those skilled in the art according to the content of reinforcing inorganic filler used in the composition of the invention.

The crosslinking system which is of use for the purposes of the invention is a vulcanization system, that is to say based on sulfur and on a vulcanization accelerator. The sulfur is typically provided in the form of molecular sulfur or of a sulfur-donating agent, preferably in molecular form. Sulfur in molecular form is also referred to by the term “molecular sulfur”. The term “sulfur donor” means any compound which releases sulfur atoms, optionally combined in the form of a polysulfide chain, which are capable of inserting into the polysulfide chains formed during the vulcanization and bridging the elastomer chains. Various known vulcanization activators, such as zinc oxide, stearic acid, guanidine derivatives (in particular diphenylguanidine), and the like, can be added to the vulcanization system, being incorporated during the first non-productive phase and/or during the productive phase. The sulfur content is preferably between 0.5 and 3.0 phr and the content of the accelerator is preferably between 0.5 and 5.0 phr. These preferential contents may apply to any one of the embodiments of the invention.

Use may be made, as (primary or secondary) vulcanization accelerator, of any compound that is capable of acting as accelerator of the vulcanization of diene elastomers in the presence of sulfur, notably accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators.

The vulcanization is carried out in a known manner at a temperature generally between 130° C. and 200° C.

The rubber composition in accordance with the invention can additionally contain other additives known to be used in rubber compositions for tyres, such as plasticizers such as hydrocarbon oils or resins, antiozonants or antioxidants.

Suitable oils are in particular nonaromatic or weakly aromatic oils, for example aliphatic oils, liquid paraffins, MES oils, TDAE oils, TRAE oils, SRAE oils, mineral oils and mixtures thereof.

Hydrocarbon resins, also known as plasticizing hydrocarbon resins, are polymers well known to those skilled in the art, essentially based on carbon and hydrogen but being able to comprise other types of atoms, for example oxygen, which can be used in particular as plasticizing agents or tackifying agents in polymer matrices. They are by nature at least partially miscible (i.e. compatible) at the contents used with the polymer compositions for which they are intended, so as to act as true diluents. They have been described, for example, in the book entitled “Hydrocarbon Resins” by R. Mildenberg, M. Zander and G. Collin (New York, V C H, 1997, ISBN 3-527-28617-9), Chapter 5 of which is devoted to their applications, notably in the tyre rubber field (5.5. “Rubber Tires and Mechanical Goods”). In a known way, these hydrocarbon resins can also be described as thermoplastic resins in the sense that they soften when heated and can thus be moulded.

According to one particular embodiment of the invention, the rubber composition comprises a plasticizing hydrocarbon resin. This embodiment is preferential when the rubber composition is used in a tyre tread.

The amount of plasticizer in the rubber composition is adjusted by those skilled in the art according to the nature of the plasticizer depending on the amount of reinforcing filler and the use for which the rubber composition is intended.

The rubber composition in accordance with the invention is typically manufactured in appropriate mixers, using two successive phases of preparation well known to those skilled in the art: a first phase of thermomechanical working or kneading (“non-productive” phase) at high temperature, up to a maximum temperature of between 130° C. and 200° C., followed by a second phase of mechanical working (“productive” phase) down to a lower temperature, typically of less than 110° C., for example between 40° C. and 100° C., during which finishing phase the crosslinking system is incorporated.

The rubber composition in accordance with the invention, which may be either in the uncured state (before crosslinking or vulcanization) or in the cured state (after crosslinking or vulcanization), can be used in a semi-finished article for a tyre, preferentially in a tyre tread.

In another subject of the invention, the tyre which comprises a tread comprises a rubber composition in accordance with the invention defined under any one of the embodiments of the invention, preferably in the tread thereof.

In summary, the invention is advantageously performed according to any one of the following embodiments 1 to 29: Embodiment 1: Rubber composition which comprises a reinforcing filler, a vulcanization system and more than 50 to 100 phr of an elastomer which contains more than 50 mol % of ethylene units and which is a copolymer of ethylene, of a first 1,3-diene which is 1,3-butadiene, isoprene or a mixture thereof, and of a second 1,3-diene of formula (I), CH₂═CR—CH═CH₂ (I), the symbol R representing an unsaturated aliphatic hydrocarbon chain having 3 to 20 carbon atoms.

Embodiment 2: Rubber composition according to embodiment 1, in which the copolymer contains more than 60 mol % of ethylene units.

Embodiment 3: Rubber composition according to either one of embodiments 1 and 2, in which the copolymer contains less than 30 mol % of units of the second 1,3-diene of formula (I).

Embodiment 4: Rubber composition according to any one of embodiments 1 to 3, in which the copolymer contains more than 60 mol % to 90 mol % of ethylene units and less than 30 mol % of units of the second 1,3-diene of formula (I).

Embodiment 5: Rubber composition according to any one of embodiments 1 to 4, in which the copolymer contains at least 70 mol % of ethylene units.

Embodiment 6: Rubber composition according to any one of embodiments 1 to 5, in which the copolymer contains from 70 mol % to 90 mol % of ethylene units.

Embodiment 7: Rubber composition according to any one of embodiments 1 to 6, in which the copolymer contains at most 20 mol % of units of the second 1,3-diene of formula (I).

Embodiment 8: Rubber composition according to any one of embodiments 1 to 7, in which the copolymer contains at most 15 mol % of units of the second 1,3-diene of formula (I).

Embodiment 9: Rubber composition according to any one of embodiments 1 to 8, in which the copolymer contains less than 30 mol % of units of the first 1,3-diene.

Embodiment 10: Rubber composition according to any one of embodiments 1 to 9, in which the copolymer contains less than 20 mol % of units of the first 1,3-diene.

Embodiment 11: Rubber composition according to any one of embodiments 1 to 10, in which the copolymer contains at most 85 mol % of ethylene units.

Embodiment 12: Rubber composition according to any one of embodiments 1 to 11, in which the copolymer contains less than 80 mol % of ethylene units.

Embodiment 13: Rubber composition according to any one of embodiments 1 to 12, in which the copolymer contains at least 1 mol % of units of the second 1,3-diene.

Embodiment 14: Rubber composition according to any one of embodiments 1 to 13, in which the copolymer contains at least 5 mol % of units of the second 1,3-diene.

Embodiment 15: Rubber composition according to any one of embodiments 1 to 14, in which the first 1,3-diene is 1,3-butadiene or a mixture of 1,3-butadiene and isoprene, and the copolymer additionally contains 1,2-cyclohexanediyl moieties.

Embodiment 16: Rubber composition according to any one of embodiments 1 to 15, in which the first 1,3-diene is 1,3-butadiene.

Embodiment 17: Rubber composition according to any one of embodiments 1 to 16, in which R contains 6 to 16 carbon atoms.

Embodiment 18: Rubber composition according to any one of embodiments 1 to 17, in which R represents an acyclic hydrocarbon chain.

Embodiment 19: Rubber composition according to any one of embodiments 1 to 18, in which R represents an unsaturated and branched acyclic hydrocarbon chain.

Embodiment 20: Rubber composition according to any one of embodiments 1 to 19, in which the copolymer has a glass transition temperature of less than −35° C.

Embodiment 21: Rubber composition according to any one of embodiments 1 to 20, in which the copolymer has a glass transition temperature of between −70° C. and −35° C.

Embodiment 22: Rubber composition according to any one of embodiments 1 to 21, in which the second 1,3-diene is myrcene, β-farnesene or a mixture of myrcene and β-farnesene.

Embodiment 23: Rubber composition according to any one of embodiments 1 to 22, in which the copolymer is a statistical copolymer.

Embodiment 24: Rubber composition according to any one of embodiments 1 to 23, in which the reinforcing filler is present at a content ranging from 30 to 200 phr.

Embodiment 25: Rubber composition according to any one of embodiments 1 to 24, in which the reinforcing filler comprises a silica which represents more than 50% by weight of the reinforcing filler.

Embodiment 26: Rubber composition according to any one of embodiments 1 to 25, which composition comprises a coupling agent for bonding the silica to the elastomer.

Embodiment 27: Tyre which comprises a tread, which tyre comprises a rubber composition defined in any one of embodiments 1 to 26.

Embodiment 28: Tyre according to embodiment 27, which tyre comprises the rubber composition in the tread thereof.

Embodiment 29: Tyre according to embodiment 27 or 28, which tyre is a pneumatic tyre.

The abovementioned characteristics of the present invention, and also others, will be better understood on reading the following description of several exemplary embodiments of the invention, which are given as nonlimiting illustrations.

### EXAMPLES

### I—Characterization of the Polymers

I-1) Determination of the Microstructure of the Polymers:

a) Determination of the Microstructure of the Ethylene-Butadiene-Myrcene Copolymers:

The spectral characterization and the measurements of the ethylene-butadiene-myrcene copolymer microstructure are carried out by nuclear magnetic resonance (NMR) spectroscopy.

For these measurements, a Bruker Avance III HD 400 MHz spectrometer is used, equipped with a Bruker cryo-BBFO z-grad 5 mm probe. The 1H experiments are recorded using a radiofrequency pulse with a tilt angle of 30°, the number of repetitions is 128 with a recycle delay of 5 seconds. The HSQC (Heteronuclear Single Quantum Coherence) and HMBC (Heteronuclear Multiple-Bond Correlation) 1H-¹³C NMR correlation experiments are recorded with a number of repetitions of 128 and a number of increments of 128. The experiments are carried out at 25° C.

25 mg of sample are dissolved in 1 ml of deuterated ortho-dichlorobenzene (ODCB).

The axes of the ¹H and ¹³C chemical shifts are calibrated with respect to the protonated impurity of the solvent at δ_{1H}=7.2 ppm (for the most shielded signal) and δ_{13C}=127 ppm (for the least shielded signal).

The possible monomer units in the copolymer are —CH₂—CH(CH═CH₂)—, —CH₂—CH═CH—CH₂—, —CH₂—CH₂—, the 1,2-cyclohexanediyl moiety and the following structures, R₁ and R₂ representing the polymer chain:

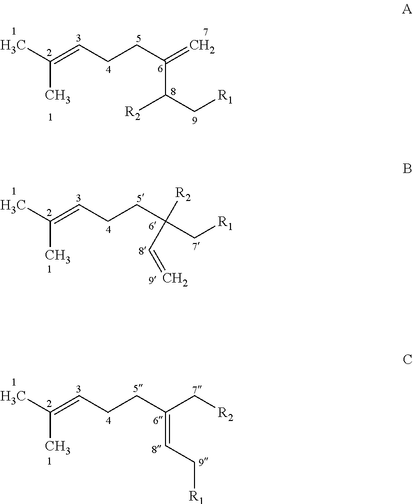

The 1,2-cyclohexanediyl moiety has the following structure:

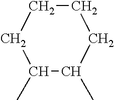

The signals of the insertion forms of myrcene A were observed on the different spectra recorded. According to S. Georges et al. (S. Georges, M. Bria, P. Zinck and M. Visseaux, Polymer, 55 (2014), 3869-3878), the signal of the —CH═ group No. 8″ characteristic of the form C exhibits identical ¹H and ¹³C chemical shifts to the —CH═ group No. 3.

The chemical shifts of the signals characteristic of the polymer are presented in Table 1 (Assignment of the ¹H and ¹³C signals of the Ethylene-Butadiene-Myrcene copolymers other than those of the units of the 1,3-butadiene).

TABLE 1

| δ¹H (ppm) | δ¹³C (ppm) | Group |
|---|---|---|
| 5.19 | 125.1 | 3 + 8″ |
| 4.86 | 109.0 | 7 |
| 1.59 and 1.68 | 247 and 17.6 | 1 |
| 1.3 | 37.5-24.0 | CH₂ ethylene |

The quantifications were carried out from the integration of the 1D ¹H NMR spectra using the Topspin software.

The integrated signals for the quantification of the various moieties are: Ethylene: All of the signals between 0.5 ppm and 3.0 ppm by subtracting the aliphatic contributions of the other moieties of the copolymer. The calculation corresponds to 4 protons of the ethylene moiety.

Form A: signal No. 7 (4.86 ppm) corresponding to 2 protons.

The proportion of form C is not directly accessible but can be calculated from the signal No. 3+8″ by subtracting the contribution of the form A.

PB1-4: Signal between 5.71 ppm and 5.32 ppm corresponds to 2 protons (by removing the PB1-2 contribution).

PB1-2: signal between 5.11 ppm and 4.92 ppm corresponds to 2 protons.

Cyclohexane rings (1,2-cyclohexanediyl moiety): signal between 1.80 ppm and 1.70 ppm corresponds to 2 protons.

The quantification of the microstructure is carried out in molar percentage (molar %) as follows: molar % of a moiety=1H integral of a moiety*100/Z(1H integrals of each moiety).

b) Determination of the Microstructure of the Ethylene-Butadiene-Farnesene Copolymers:

The spectral characterization and the measurements of the ethylene-butadiene-farnesene copolymer microstructure are carried out by Nuclear Magnetic Resonance (NMR) spectroscopy. For these measurements, a Bruker Avance III HD 400 MHz spectrometer is used, equipped with a Bruker cryo-BBFO z-grad 5 mm probe. The ¹H experiments are recorded using a radiofrequency pulse with a tilt angle of 30°, the number of repetitions is 128 with a recycle delay of 5 seconds. The HSQC (Heteronuclear Single Quantum Coherence) and HMBC (Heteronuclear Multiple-Bond Correlation) ¹H-¹³C NMR correlation experiments are recorded with a number of repetitions of 128 and a number of increments of 128. The experiments are carried out at 25° C. 25 mg of sample are dissolved in 1 ml of deuterated ortho-dichlorobenzene (ODCB). The axes of the ¹H and ¹³C chemical shifts are calibrated with respect to the protonated impurity of the solvent at δ_{1H}=7.2 ppm (for the most shielded signal) and δ_{13C}=127 ppm (for the least shielded signal).

The possible monomer units in the copolymer are —CH₂—CH(CH═CH₂)—, —CH₂—CH═CH—CH₂—, —CH₂—CH₂—, the 1,2-cyclohexanediyl moiety and the following structures, R₁ and R₂ representing the polymer chain:

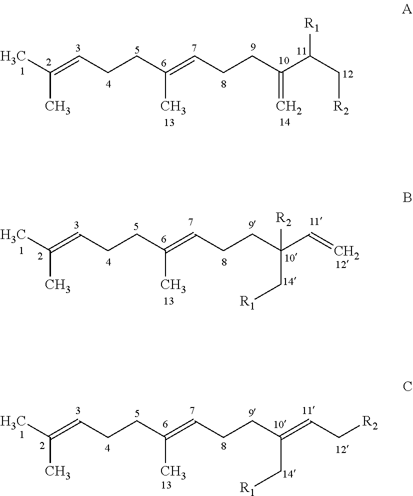

The signals of the insertion form of farnesene A were observed on the different spectra recorded. The signal of the —CH═ group No. 11″ characteristic of the form C exhibits identical ¹H and ¹³C chemical shifts to the —CH=groups No. 3 and No. 7.

The chemical shifts of the signals characteristic of the polymer are presented in Table 2 (Assignment of the ¹H and ¹³C signals of the Ethylene-Butadiene-Farnesene copolymers other than those of the units of the 1,3-butadiene).

TABLE 2

| δ¹H (ppm) | δ¹³C (ppm) | Group |
|---|---|---|
| 5.25 | 125.0 | 7 |
| 5.15 | 125.0 | 3, 11″ |
| 4.87 | 109.0 | 14 |
| 1.59and1.67 | 24.6and17.5 | 1, 13 |
| 1.28 | 38-24.0 | CH₂ ethylene |

The quantifications were carried out from the integration of the 1D ¹H NMR spectra using the Topspin software.

The integrated signals for the quantification of the various moieties are:
Farnesene moiety form A from the signal No. 14 CH₂═ for 2 protons,
Farnesene moiety form C from the signals No. 3, 11″ and No. 7 CH═ (by subtracting the contribution of the form A), for 2 protons,
Farnesene moiety form B: from the signal No. 11′, specific to this form, for 1 proton.
PB1-4: Signal between 5.71 ppm and 5.32 ppm corresponds to 2 protons (by removing the PB1-2 contribution).
PB1-2: signal between 5.11 ppm and 4.92 ppm corresponds to 2 protons.
Cyclohexane rings (1,2-cyclohexanediyl moiety): signal between 1.80 ppm and 1.70 ppm corresponds to 2 protons.

Ethylene moiety by integrating all of the aliphatic signals (from ^{˜}0.5 to 3 ppm) and by subtracting the contribution of all the other aliphatic moieties (PB1-4, PB1-2, EBR ring, farnesene forms A and C).

The quantification of the microstructure is carried out in molar percentage (molar %) as follows:

molar % of a moiety=¹H integral of a moiety*100/Σ(¹H integrals of each moiety).

I-2) Determination of the glass transition temperature of the polymers:

The glass transition temperature is measured by means of a differential calorimeter (differential scanning calorimeter) according to Standard ASTM D3418 (1999).

I-3) Determination of the macrostructure of the polymers by size exclusion chromatography (SEC):

a) Principle of the Measurement:

Size-exclusion chromatography or SEC makes it possible to separate macromolecules in solution according to their size by passage through columns packed with a porous gel. The macromolecules are separated according to their hydrodynamic volume, the bulkiest being eluted first.

In combination with 3 detectors (3D)—a refractometer, a viscometer and a 90° light-scattering detector—SEC gives a picture of the distribution of the absolute molar masses of a polymer. The various number-average (Mn) and weight-average (Mw) absolute molar masses and the dispersity (D=Mw/Mn) can also be calculated.

b) Preparation of the Polymer:

Each sample is dissolved in tetrahydrofuran at a concentration of approximately 1 g/l. The solution is then filtered through a filter with a porosity of 0.45 μm before injection.

c) 3D Sec Analysis:

In order to determine the number-average molar mass (Mn), and if appropriate the weight-average molar mass (Mw) and the polydispersity index (PI), of the polymers, the method below is used.

The number-average molar mass (Mn), the weight-average molar mass (Mw) and the polydispersity index of the polymer (hereinafter sample) are determined in an absolute manner by triple detection size exclusion chromatography (SEC). Triple detection size exclusion chromatography has the advantage of measuring average molar masses directly without calibration.

The value of the refractive index increment dn/dc of the solution of the sample is measured in line using the area of the peak detected by the refractometer (RI) of the liquid chromatography equipment. In order to apply this method, it must be confirmed that 100% of the sample mass is injected and eluted through the column. The area of the RI peak depends on the concentration of the sample, on the constant of the RI detector and on the value of the dn/dc.

In order to determine the average molar masses, use is made of the 1 g/l solution previously prepared and filtered, which is injected into the chromatographic system. The apparatus used is a Waters Alliance chromatographic line. The elution solvent is tetrahydrofuran containing 250 ppm of BHT (2,6-di(tert-butyl)-4-hydroxytoluene), the flow rate is 1 ml·min⁻¹, the temperature of the system is 35° C. and the analytical time is 60 min. The columns used are a set of three Agilent columns of PL Gel Mixed B LS trade name. The volume of the solution of the sample injected is 100 μl. The detection system is composed of a Wyatt differential viscometer of Viscostar II trade name, of a Wyatt differential refractometer of Optilab T-Rex trade name of wavelength 658 nm and of a Wyatt multi-angle static light scattering detector of wavelength 658 nm and of Dawn Heleos 8+ trade name.

For the calculation of the number-average molar masses and the polydispersity index, the value of the refractive index increment dn/dc of the solution of the sample obtained above is integrated. The software for processing the chromatographic data is the Astra system from Wyatt.

### II—Characterization of Rubber Compositions

II-1) Vulcanization Properties:

The measurements are performed at 150° C. with an oscillating-chamber rheometer, according to the Standard DIN 53529—Part 3 (June 1983). The change in the rheometric torque as a function of the time describes the change in the stiffening of the composition as a result of the vulcanization reaction. The measurements are processed according to the Standard DIN 53529—Part 2 (March 1983). Ta (for example T90) is the time necessary to achieve a conversion of a %, that is to say a % (for example 90%) of the difference between the minimum and maximum torques.

II-2) Stiffness and Hysteresis of the Rubber Compositions:

The dynamic properties are measured on a viscosity analyser (Metravib VA4000) according to Standard D 5992-96. The response of a sample of vulcanized composition (cylindrical test specimen with a thickness of 4 mm and a cross section of 400 mm²), subjected to a simple alternating sinusoidal shear stress at an imposed stress of 0.7 MPa and at a frequency of 10 Hz, during a temperature sweep, from a minimum temperature below the Tg of the elastomers of the compositions up to a maximum temperature above 100° C., is recorded. The results made use of are the complex dynamic shear modulus (G*) and the loss factor tan 6; the values of G* are taken at the temperature of 60° C. and the loss factor tan 6 at 20° C. and 60° C.

The stiffness and hysteresis results are expressed in base 100 relative to a control taken as reference. A value of less than 100 indicates a value lower than that of the control.

### III—Preparation of the Elastomers

Synthesis of an Ethylene/1,3-Butadiene Copolymer:

A copolymer of ethylene and of 1,3-butadiene E1 is synthesized according to the following procedure:

Butyloctylmagnesium (BOMAG) is added to a reactor containing, at 80° C., methylcyclohexane, ethylene (Eth) and 1,3-butadiene (Btd) in the proportions indicated in Table 3, to neutralize the impurities in the reactor, then the catalytic system is added (cf. Table 3). At this time, the reaction temperature is regulated at 80° C. and the polymerization reaction starts. The polymerization reaction takes place at a constant pressure of 8 bar. The reactor is fed throughout the polymerization with ethylene and 1,3-butadiene in the proportions defined in Table 3. The polymerization reaction is stopped by cooling, degassing of the reactor and addition of ethanol. An antioxidant is added to the polymer solution. The copolymer E1 is recovered by drying in an oven under vacuum to constant mass.

The catalytic system is a preformed catalytic system. It is prepared in methylcyclohexane from a metallocene, [Me₂Si(Flu)₂Nd(μ-BH₄)₂Li(THF)], a co-catalyst, butyloctylmagnesium (BOMAG), and a preformation monomer, 1,3-butadiene, in the contents indicated in Table 3. It is prepared according to a preparation method in accordance with paragraph 11.1 of patent application WO 2017093654 A1.

TABLE 3

| Metallocene | Alkylating agent | Preformation | Feed |
|---|---|---|---|
| concentration | concentration | monomer/Nd | composition |
| (mmol/L) | (mmol/L) | metal molar ratio | (mol % Eth/Bdt) |
| 0.07 | 0.36 | 90 | 80/20 |

Synthesis of Ethylene/Butadiene/Farnesene Copolymers:

Two copolymers E2 and E3 are synthesized according to the following procedure:

Butyloctylmagnesium (BOMAG) is added to a reactor containing, at 80° C., methylcyclohexane, 1,3-butadiene and β-farnesene in the proportions indicated in Table 4, to neutralize the impurities in the reactor, then the catalytic system is added (cf. Table 4). At this time, the reaction temperature is regulated at 80° C. and the polymerization reaction starts. The polymerization reaction takes place at a constant pressure of 8 bar. The reactor is fed throughout the polymerization with ethylene, 1,3-butadiene and β-farnesene in the proportions defined in Table 4. The polymerization reaction is stopped by cooling, degassing of the reactor and addition of ethanol. An antioxidant is added to the polymer solution. The copolymer is recovered by drying in an oven under vacuum to constant mass.

The catalytic system is a preformed catalytic system. It is prepared in methylcyclohexane from a metallocene, [Me₂Si(Flu)₂Nd(μ-BH₄)₂Li(THF)], a co-catalyst, butyloctylmagnesium (BOMAG), and a preformation monomer, 1,3-butadiene, in the contents indicated in Table 4. It is prepared according to a preparation method in accordance with paragraph 11.1 of patent application WO 2017093654 A1.

TABLE 4

| | | Alkylating | Preformation | Feed |
|---|---|---|---|---|
| | Metallocene | agent | monomer/Nd | composition |
| Copol- | concentration | concentration | metal molar | (mol % |
| ymer | (mmol/L) | (mmol/L) | ratio | Eth/Bdt) |
| E2 | 0.10 | 0.4 | 90 | 84/9/7 |
| E3 | 0.09 | 0.25 | 90 | 81/9/10 |

Synthesis of an Ethylene/Butadiene/Myrcene Copolymer:

An E4 copolymer is synthesized according to the following procedure:

Butyloctylmagnesium (BOMAG) is added to a reactor containing, at 80° C., methylcyclohexane, ethylene, 1,3-butadiene and myrcene in the proportions indicated in Table 5, to neutralize the impurities in the reactor, then the catalytic system is added (cf. Table 5). At this time, the reaction temperature is regulated at 80° C. and the polymerization reaction starts. The polymerization reaction takes place at a constant pressure of 8 bar. The reactor is fed throughout the polymerization with ethylene, 1,3-butadiene and myrcene in the proportions defined in Table 5. The polymerization reaction is stopped by cooling, degassing of the reactor and addition of ethanol. An antioxidant is added to the polymer solution. The copolymer is recovered by drying in an oven under vacuum to constant mass.

The catalytic system is a preformed catalytic system. It is prepared in methylcyclohexane from a metallocene, [Me2Si(Flu)2Nd(μ-BH4)2Li(THF)], a co-catalyst, butyloctylmagnesium (BOMAG), and a preformation monomer, 1,3-butadiene, in the contents indicated in Table 5. It is prepared according to a preparation method in accordance with paragraph 11.1 of patent application WO 2017093654 A1.

TABLE 5

| | | Alkylating | Preformation | Feed |
|---|---|---|---|---|
| | Metallocene | agent | monomer/Nd | composition |
| Copol- | concentration | concentration | metal molar | (mol % |
| ymer | (mmol/L) | (mmol/L) | ratio | Eth/Bdt) |
| E4 | 0.09 | 0.4 | 90 | 73/15/12 |

The microstructure of the elastomers E1 to E4 is shown in Table 6, which indicates the molar contents of the ethylene (Eth) units, the 1,3-butadiene units, the 1,2-cyclohexanediyl (ring) moieties, and β-farnesene or myrcene units. Table 6 also shows the molar proportion of β-farnesene units or myrcene units according to whether they are of the 1.4 configuration, the 1.2 configuration and the 3.4 configuration and the number-average molar mass measured according to paragraph I-3).

TABLE 6

| | | | | | | | | | Mn |
|---|---|---|---|---|---|---|---|---|---|
| Elastomer | Eth | Btd | ring | Far or Myr | | 1.4 | 1.2 | 3.4 | (g/mol) |
| E1 | 78 | 14 | 8 | — | | — | — | — | 128888 |
| E2 | 79 | 8 | 5 | 8 | (Far) | 37 | <1 | 63 | 161000 |
| E3 | 76 | 8 | 5 | 11 | (Far) | 36 | <1 | 64 | 200800 |
| E4 | 71 | 15 | 6 | 8 | (Myr) | 37 | <1 | 63 | 133000 |

### IV—Preparation of the Rubber Compositions

Rubber compositions, the formulation of which is expressed in phr (parts by weight per hundred parts of elastomer) is shown in Table 7, were prepared in an internal mixer into which the copolymer, the reinforcing filler and also the various other ingredients except the vulcanization system are introduced. Thermomechanical working (non-productive phase) is then carried out in one step, which lasts in total approximately 5 min, until a maximum “dropping” temperature of 150° C. is reached. The mixture thus obtained is recovered and cooled and then sulfur and the accelerator are incorporated on a mixer (homofinisher) at 40° C., everything being mixed (productive phase) for approximately ten minutes. The compositions thus obtained are then calendered either in the form of slabs (thickness of 2 to 3 mm) or of thin sheets of rubber for the measurement of their physical or mechanical properties after vulcanization at 150° C. The crosslinking time applied, T(99), is the time required for the torque of the composition to reach 99% of the maximum torque of the composition.

Composition C1 which contains the elastomer E1, a copolymer of ethylene and 1,3-butadiene, is a composition not in accordance with the invention. Compositions C2 to C4 which respectively contain the elastomers E2 to E4 are compositions in accordance with the invention.

TABLE 7

| Composition | C1 | C2 | C3 | C4 |
|---|---|---|---|---|
| Elastomer E1 | 100 | — | — | — |
| Elastomer E2 | — | 100 | — | — |
| Elastomer E3 | — | — | 100 | — |
| Elastomer E4 | — | — | — | 100 |
| Carbon black(1) | 4 | 4 | 4 | 4 |
| Silica(2) | 98 | 98 | 98 | 98 |
| Liquid plasticizer(3) | 4 | 4 | 4 | 4 |
| Plasticizing resin(4) | 47 | 47 | 47 | 47 |
| Antioxidant | 5.4 | 5.4 | 5.4 | 5.4 |
| Antiozonant wax | 2.5 | 2.5 | 2.5 | 2.5 |
| Coupling agent(5) | 10 | 10 | 10 | 10 |
| Stearic acid(6) | 4 | 4 | 4 | 4 |
| DPG (7) | 2.1 | 2.1 | 2.1 | 2.1 |
| ZnO (8) | 1 | 1 | 1 | 1 |
| Accelerator (9) | 2.4 | 2.4 | 2.4 | 2.4 |
| Sulfur | 1 | 1 | 1 | 1 |

(1)N234
(2)Zeosil 1165 MP, from Solvay-Rhodia, in the form of micropearls
(3)MES/HPD (Catenex SNR from Shell)
(4)Escorez 5600 C9/Dicyclopentadiene hydrocarbon resin from Exxon (Tg = 52° C.)
(5)TESPT (Si69 from Evonik)
(6)Stearin, Pristerene 4931 from Uniquema
(7) Diphenylguanidine
(8) Zinc oxide, industrial grade from Umicore
(9) N-Cyclohexyl-2-benzothiazolesulfenamide (Santocure CBS from Flexsys)

V-Results:

The results are given in Table 8. They are expressed in base 100 relative to Composition C1 taken as control. A value of less than 100 indicates a value lower than that of the control.

TABLE 8

| Composition | C1 | C2 | C3 | C4 |
|---|---|---|---|---|
| G* 60° C. | 100 | 63 | 70 | 85 |
| tanδ 20° C. | 100 | 90 | 85 | 96 |
| tanδ 60° C. | 100 | 91 | 78 | 87 |
| T90 | 100 | 43 | 41 | 54 |

Compositions C2 to C4 exhibit lower stiffness than Composition C1, even though the ethylene contents are comparable. The hysteresis of Compositions C2 to C4 is also lower than that of C1. The time required for vulcanization of the rubber compositions is also greatly reduced given the T90 values much lower than 100. The curing, hysteresis and stiffness properties of the rubber compositions in accordance with the invention are all improved.

1. A rubber composition which comprises a reinforcing filler, a vulcanization system and more than 50 to 100 phr of an elastomer which contains more than 50 mol % of ethylene units and which is a copolymer of ethylene, of a first 1,3-diene which is 1,3-butadiene, isoprene or mixture thereof, and of a second 1,3-diene of formula (I), CH₂═CR—CH═CH₂ (I), the symbol R representing an unsaturated aliphatic hydrocarbon chain having 3 to 20 carbon atoms.

2. The rubber composition according to claim 1, in which the copolymer contains more than 60 mol % of ethylene units.

3. The rubber composition according to claim 1, in which the copolymer contains at most 85 mol % of ethylene units.

4. The rubber composition according to claim 1, in which the copolymer contains less than 30 mol % of units of the second 1,3-diene of formula (I).

5. The rubber composition according to claim 1, in which the copolymer contains less than 30 mol % of units of the first 1,3-diene or less than 20 mol % of units of the first 1,3-diene.

6. The rubber composition according to claim 1, in which the copolymer contains at least 1 mol % of units of the second 1,3-diene.

7. The rubber composition according to claim 1, in which the copolymer contains at least 5 mol % of units of the second 1,3-diene.

8. The rubber composition according to claim 1, in which the copolymer contains less than 80 mol % of ethylene units.

9. The rubber composition according to claim 1, in which the first 1,3-diene is 1,3-butadiene.

10. The rubber composition according to claim 1, in which the second 1,3-diene is myrcene, β-farnesene or a mixture of myrcene and β-farnesene.

11. The rubber composition according to claim 1, in which the copolymer is a statistical copolymer.

12. The rubber composition according to claim 1, in which the reinforcing filler is present at a content ranging from 30 to 200 phr.

13. The rubber composition according to claim 1, in which the reinforcing filler comprises a silica which represents more than 50% by weight of the reinforcing filler.

14. A tire which comprises a tread, which tire comprises a rubber composition defined in claim 1.
